(19) United States
(12) Patent Application Publication
(10) Pub. No.: US 2004/0113586 A1
(43) Pub. Date: Jun. 17, 2004

(54) Charge-type voltage balancing device

(76) Inventor: Seng-Feng Chen, Taipei Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/407,383

(22) Filed: Apr. 4, 2003

(30) Foreign Application Priority Data
Dec. 13, 2002 (TW) 091136216

(51) Int. Cl. H02J 7/00

(52) U.S. Cl. 320/118

(57) ABSTRACT

A charge-type voltage balancing device including a first battery cell, a second battery cell, a switching device, and a controller is provided according to the invention. The first battery cell and the second battery cell are connected in series; the switching device, coupled to a capacitor, connects the capacitor in parallel with either the first battery cell or the second battery cell; the controller, coupled to the switching device, periodically alternates the on/off status of the switch so the capacitor can be alternately connected in parallel with either the first battery cell or the second battery cell. The energy of the battery cell whose voltage level is higher is transferred to the capacitor, and then the battery cell whose voltage level is lower is charged in order to achieve a voltage balance.

This application claims the benefit of Taiwan application Serial No. 91136216, filed Dec. 13, 2002.

### BACKGROUND OF THE INVENTION

1. Field of the Invention

The invention relates in general to a voltage balancing device, and more particularly to a charge-type voltage balancing device.

2. Description of the Related Art

In consequence of the rapid growth in the industry of electronic products, portable electronic devices such as notebook computer, personal digital assistant (PDA) and mobile phone have won great popularity nowadays. In order to satisfy the consumers' various needs, the design of portable electronic products has to take into consideration not only the miniaturization and handiness of the product, but also the duration and service life of the battery module. Manufacturers of electronic products have already invested a great amount of capital and human resources in research and development hoping that they can outdo their competitors and grab a better chance in the market.

The battery module, which is an essential element for portable electronic devices, includes a number of serial battery cells providing the necessary power for the operation of a portable electronic device. The battery cells used can be lithium batteries for example. When battery cells are connected in series over a period of time, electric voltage differences among battery cells will arise because the discharging rate for individual battery cell is different. Even a small voltage difference would attenuate the capacity of a battery module; the larger the voltage difference is, the worse the fading rate will be. When the difference is too large, the battery module would even become unusable.

The conventional method way in resolving the problem of voltage difference among battery cells is to discharge those battery cells with higher voltages so that the voltage of each battery cell can achieve a balanced status. Voltage balance means each battery cell has about the same voltage level. Please refer to FIG. 1, a schematic diagram for a conventional voltage balancing device. As it is shown in the diagram, the four battery cells BT1, BT2, BT3 and BT4 are connected in series with each of their two ends being connected to a resistor; the four switches, SW1, SW2, SW3, and SW4, control the time point of the formation of the discharge loop. For example, when battery cells BT1, BT2, BT3 and BT4 are voltage balanced, switches SW1, SW2, SW3, and SW4 will be turned off to break the loop so the discharging of battery cells will be discontinued. Afterwards, if the voltage of BT1 is detected to be higher than that of other battery cells, controller 110 will turn switch SW1 on to forming the discharge loop for battery cell BT1, allowing battery cell BT1 to discharge through resistor R1, switch SW1 and resistor R2. When the voltage of battery cell BT1 equals to that of other battery cells, controller 110 will turn off switch SW1 to break the discharge loop, bringing an end to the discharge process.

The most common way for detecting each battery cell voltage is to sample the voltage level at end points A, B, C, and D by an analog to digital converter to obtain the voltage of each battery cell. After that, the voltages of all battery cells are analog-to-digital converted, and then the digital battery cell voltages are compared to each other. Suppose some battery cells need to be discharged, controller 110 will switch on the corresponding switches of the battery cells that need to be discharged and turn these switches off to finish the discharge process when voltage balance among battery cells has been achieved.

In the above disclosure, the conventional practice discharges those battery cells with higher voltages until a voltage balance between high voltage battery cells and low voltage battery cells is achieved. It is obvious that this way will still certainly cause electrical energy loss, attenuating the duration of the battery module. In other words, the conventional voltage balancing method uses low voltage battery cells as reference standard and discharge high voltage battery cells accordingly. Despite that voltage balance can finally be achieved, electrical energy loss of battery cells is heavy and fast. Therefore the conventional voltage balancing method needs to be further improved to reduce electrical energy loss.

### SUMMARY OF THE INVENTION

It is therefore an object of the invention to provide a charge-type voltage balancing device, which, aside from achieving a voltage balance among battery cells, reduces electrical energy loss and improves battery duration.

It is another object of the invention to provide a charge-type voltage balancing device disclosed below.

A charge-type voltage balancing device includes a first battery cell, a second battery cell, a switching device and a controller. The first battery cell and the second battery cell are connected in series; the switching device, coupled to a capacitor, connects the capacitor in parallel with either the first battery cell or the second battery cell; the controller, coupled to the switching device, periodically alternates the on/off status of the switch so the capacitor can be alternately connected in parallel with either the first battery cell or the second battery cell. The energy of the battery cell with a higher voltage level is transferred to the capacitor, and then the battery cell with a lower voltage level is charged in order to achieve a voltage balance.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 shows a conventional voltage balancing device;

FIG. 2 shows a circuit diagram for a charge-type voltage balancing device according to a preferred embodiment of the invention; and

FIG. 3, which shows a charge-type voltage balancing device applied to balance voltages of four battery cells.

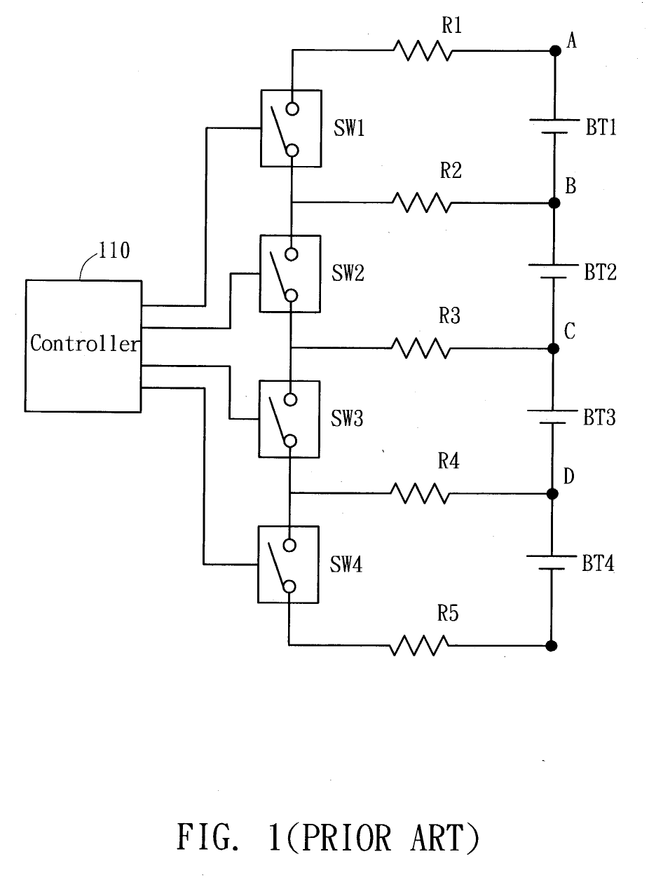

### DETAILED DESCRIPTION OF THE INVENTION

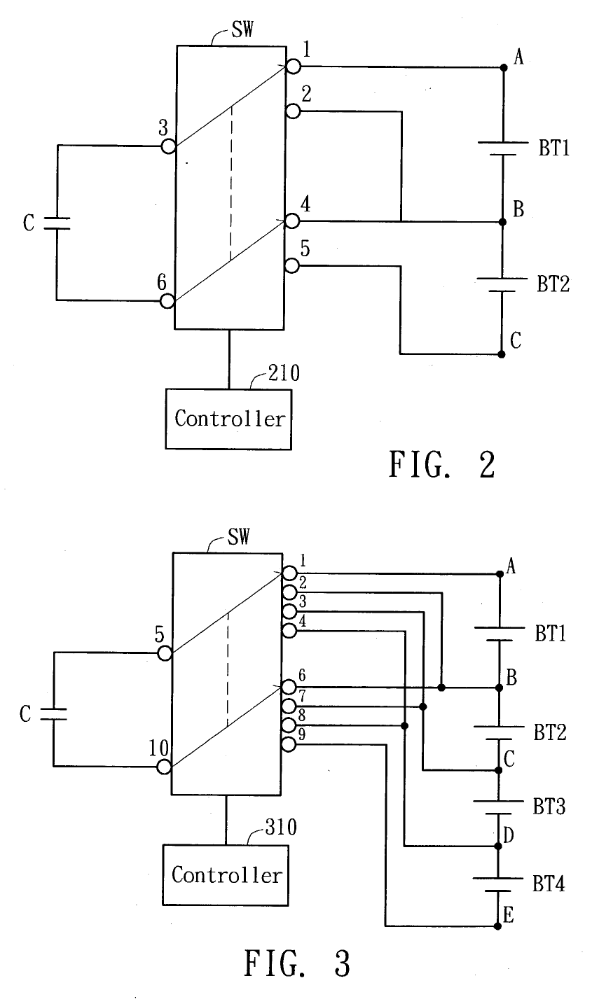

The invention provides a charge-type voltage balancing device, which can be set in a battery module, achieving a voltage balance via the charge and discharge of a capacitor, improving the duration of battery life. The battery module with such function can be set in portable electronic devices such as notebook computer, PDA or mobile phone. Please refer to FIG. 2, a charge-type voltage balancing device according to a preferred embodiment of the invention. Battery cells BT1 and BT2 are connected in series with the two end points of each battery cell being coupled to a switching device. In other words, end point A and end point B, the two end points of BT1, are coupled to end point 1 and end point 4 of the switching device SW; end point B and end point C, the two end points of BT2, are coupled to end point 2 and end point 5 of the switching device SW. End point 2 and end point 4 of the switching device SW are coupled together. Meanwhile, switching device SW can be coupled to the two end of capacitor C via end point 3 and end point 6. Capacitor C can be connected in parallel to battery cell BT1 or battery cell BT2 according to the on/off status of the switching device SW. That is to say, capacitor C will never be connected in parallel to both BT1 and BT2 at the same time.

In practical application, switch device SW can be a linked switch, an electronic linked switch for instance. A linked switch refers to two switches, which, being linked together, can only be switched on or switched off at the same time but cannot be switched on or off separately. Take FIG. 2 for example. Two switch sets are installed in switching device SW, wherein the first switch set is used to change the linking relationship among end point 1, end point 2, and end point 3 while the second switch set is used to change the linking relationship among end point 4, end point 5, and end point 6. Under the first on/off status, when end point 3 is connected to end point 1, end point 6 will be connected to end point 4 as well; meanwhile, capacitor C and battery cell BT1 will be connected in parallel. Since the first switch set and the second switch set are linked up, the first on/off status alternates with the second on/off status. Under the second on/off status, when end point 3 is connected to end point 2, end point 6 will be connected to end point 5 as well; meanwhile, capacitor C and battery cell BT2 will be connected in parallel.

The switching status of switching device SW can be controlled via controller 210. In practice, controller 210 can use a clock signal to connect capacitor C to battery cells BT1 and BT2 in parallel alternately. When capacitor C is connected to battery cell BT1 during time 1, the voltage of capacitor C equals to that of battery cell BT1. When capacitor C is connected to battery cell BT2 during time 2, if the voltage of battery cell BT1 is higher than that of battery cell BT2, the capacitor C will be discharged and the battery cell BT2 will be charged due to the voltage that capacitor C had built up during time 1 is larger than the voltage of battery cell BT2. Conversely, if the voltage of battery cell BT1 is lower than that of battery cell BT2, the voltage that capacitor C had built up during time 1 will be lower than that of battery cell BT2. When capacitor C is connected in parallel to battery cell BT2 during time 2, battery cell BT2 will continue to charge capacitor C such that capacitor C can be used to charge BT1 when capacitor C is connected in parallel to BT1 during time 3. By connecting capacitor C to battery cell BT1 and battery cell BT2 alternately, the battery cell with a higher voltage will charge the battery cell with a lower voltage via capacitor C. Consequently, a voltage balance will be achieved.

Of course, the charge-type voltage balancing device can be applied to balance voltages of several battery cells. Refer to FIG. 3, which shows a charge-type voltage balancing device applied to balance voltages of four battery cells. Similarly, controller 310 can sequentially turn on and turn off the switches of the switch device SW to make capacitor C be connected in parallel with battery cells BT1, BT2, BT3, and BT4 periodically. Therefore, the battery cells with higher voltage will charge the capacitor C and the capacitor C will charge the battery cells with lower voltage, and the voltage balance will be achieved.

The charge-type voltage balancing device disclosed in the above embodiment of the invention uses a capacitor to transfer battery energy from the battery cell whose voltage level is higher to the battery cell whose voltage level is lower, which not only achieves voltage balance but also reduces energy loss. The conventional method uses a resistor to consume the energy of the battery cell whose voltage level is high, causing a large amount of energy loss. In comparison with the conventional method, the present invention uses battery energy more efficiently, thus improves the duration of battery and prolongs its service life.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A charge-type voltage balancing device, comprising:
a first battery cell;
a second battery cell connected to the first battery cell in series;
a switching device coupled to the first battery cell and the second battery cell, wherein the switch device is further coupled to a capacitor which is connected to either the first battery cell or the second battery cell in parallel according to a status of the switching device; and
a controller, coupled to the switching device, for alternating the status of the switching device.

2. The charge-type voltage balancing device according to claim 1, wherein the controller, which controls the switching device, makes the capacitor been periodically connected in parallel with the first battery cell or the second battery cell, and the capacitor charges the first battery cell or the second battery cell depending on which one has a lower voltage.

3. The charge-type voltage balancing device according to claim 1, wherein the switching device is an electronic linked switch.

4. The charge-type voltage balancing device according to claim 1, wherein the charge-type voltage balancing device is installed in a portable electronic device.

5. The charge-type voltage balancing device according to claim 4, wherein the portable electronic device has a battery module into which the charge-type voltage balancing device is integrated.

6. The charge-type voltage balancing device according to claim 5, wherein the first battery cell and the second battery cell are lithium batteries.

7. The charge-type voltage balancing device according to claim 5, wherein the portable electronic device is a notebook computer.

8. The charge-type voltage balancing device according to claim 5, wherein the portable electronic device is a personal digital computer (PDA).

9. The charge-type voltage balancing device according to claim 5, wherein the portable electronic device is a mobile phone.

10. A charge-type voltage balancing device installed in a battery module of a portable electronic device, wherein the charge-type voltage balancing device comprises:
a first battery cell;
a second battery cell connected to the first battery cell in series;
a linked switch, coupled to the first battery cell and the second battery cell, wherein the linked switch is further coupled to a capacitor which is connected in parallel to either the first battery cell or the second battery cell according to the status of the linked switch; and
a controller, coupled to the switching device, for alternating the status of the linked switch;
wherein the controller, which controls the linked switch, makes the capacitor been periodically connected in parallel with the first battery cell or the second battery cell, and, by means of the capacitor, the first battery cell or the second battery cell is charged depending on which one has a lower voltage level.

11. The charge-type voltage balancing device according to claim 10, wherein the first battery cell and the second battery cell are lithium batteries.

12. The charge-type voltage balancing device according to claim 10, wherein the portable electronic device is a notebook computer.

13. The charge-type voltage balancing device according to claim 10, wherein the portable electronic device is a PDA.

14. The charge-type voltage balancing device according to claim 10, wherein the portable electronic device is a mobile phone.
